(19) United States
(12) Patent Application Publication
(10) Pub. No.: US 2003/0097801 A1
(43) Pub. Date: May 29, 2003

(54) Folding covering panels for expanding structures

(76) Inventor: Charles Hoberman, New York, NY (US)

Correspondence Address: DICKSTEIN SHAPIRO MORIN & OSHINSKY LLP, 1177 AVENUE OF THE AMERICAS, NEW YORK, NY, 10038-2714, US

(21) Appl. No.: 10/303,550

(22) Filed: Nov. 25, 2002

Related U.S. Application Data
(60) Provisional application No. 60/333,418, filed on Nov. 26, 2001.

(51) Int. Cl. E04B 1/34; B62D 63/04; E04B 7/08

(52) U.S. Cl. 52/3; 52/81.2

(57) ABSTRACT

Reversibly expanding covering elements for truss structures made up of scissor-assemblies that are connected together by hub elements structures. These covering elements are comprised of a folded sheet of flexible material such as cardboard or a plastic sheet, or alternatively, comprised of planar panels that are hinged together. As the truss structure expands and contracts, the covering element is compressed and expanded along with it.

### RELATED APPLICATIONS

This application claims the filing date of provisional patent application No. 60/333,418, filed Nov. 26, 2001.

### BACKGROUND OF THE INVENTION

Structures that transform in size or shape have numerous applications in many fields. My prior patent, U.S. Pat. No. 5,024,031, hereby incorporated by reference as if fully disclosed herein, teaches methods for constructing expandable truss-structures in a variety of shapes. The teachings therein have been used to build structures for diverse applications including architectural uses, public exhibits and unique folding toys.

Such a truss structure is made up of scissor-assemblies (or “tong-assemblies”) that are connected together by hub elements. These scissor-assemblies form an open lattice-like structure that may be reversibly expanded and contracted. The structures previously disclosed are essentially expandable frameworks, no covering surfaces within the framework were provided. Such a framework can be improved upon.

It is, therefore, an object of this invention to provide covering surfaces within the framework of these scissor-assemblies.

It is a further object to provide covering surfaces for these scissor-assemblies that have a degree of structural integrity and have controlled movement when the scissor-assemblies expand and contract.

It is a further object ofthis invention to provide novel structures that, in their contracted state, have empty spaces within which the covering elements are housed. The covering elements, therefore, do not protrude outside of the contracted structure's profile.

It is a related object to provide novel structures that, in their extended state, the covering elements span the polygonal openings that are bordered by scissor assemblies, and are thus capable of providing an essentially complete and continuous surface.

The above and related objects are addressed by the instant invention.

### SUMMARY OF THE INVENTION

I have invented a novel method of providing reversibly expanding covering elements for truss structures made up of scissor-assemblies that are connected together by hub elements structures. These covering elements are comprised of planar panels that are hinged together, or alternatively, comprised of a folded sheet of flexible material such as paper or a plastic sheet.

The benefits of such a technique are multiple. By providing a “skin” to the expandable truss structures, numerous new applications are possible. Such applications may include portable shelters, transformable lighting products, toys and games that expand with printed images, and foldable projection screens.

The disclosed invention thus represents a significant advance over the earlier invention, and can lead to numerous practical embodiments.

### BRIEF DESCRIPTION OF THE DRAWINGS

In the drawings:

FIGS. 1-4 show a covering element according to the invention.

FIGS. 5-7 show a covering element attached to three tong linkages.

FIG. 8 shows an alternate embodiment of the covering element comprised of a central six-sided polygonal element and three extensions.

FIGS. 9-11 show the covering element of FIG. 8 connected to three tong linkages, forming a closed-loop element with covering element.

FIG. 12 shows a covering element which is comprised of a ten-sided polygonal element and five extensions.

FIGS. 13-15 show the covering element of FIG. 12 attached to five tong linkages.

FIGS. 16-18 show an expanding sphere consisting of sixty tong linkages, twelve pentagonal covering elements and twenty triangular covering elements.

FlGS. 19-21 show an expanding dome consisting of thirty-five tong linkages, six pentagonal elements and ten triangular elements.

FIGS. 22-23 show an expanding sphere consisting of twenty-four tong linkages and six square covering elements.

### DETAILED DESCRIPTION

FIG. 1 shows a plan view of a covering element 50 consisting of a central hexagonal polygonal area 40, and three extensions 42, 44 and 46. In the preferred embodiment, the covering element 50 and the three extensions 42, 44 and 46 are constructed out of a single piece of material such as strong paper or cardboard that can withstand repeated folding and unfolding. Alternatively, plastics or other similar foldable materials may be used. Hexagonal Central area 40 is comprised of six triangular panels 1, 2, 3, 4, 5 and 6 which are formed by folds 47, 48 and 49 in the material of the covering element. Extension 42 is comprised of four triangular panels 10, 11, 12 and 13 and is formed by folds 47a and 48a in the material of the covering element. Likewise extensions 44 and 46 are formed by folds in the covering element and are on the same piece of material as central area 40.

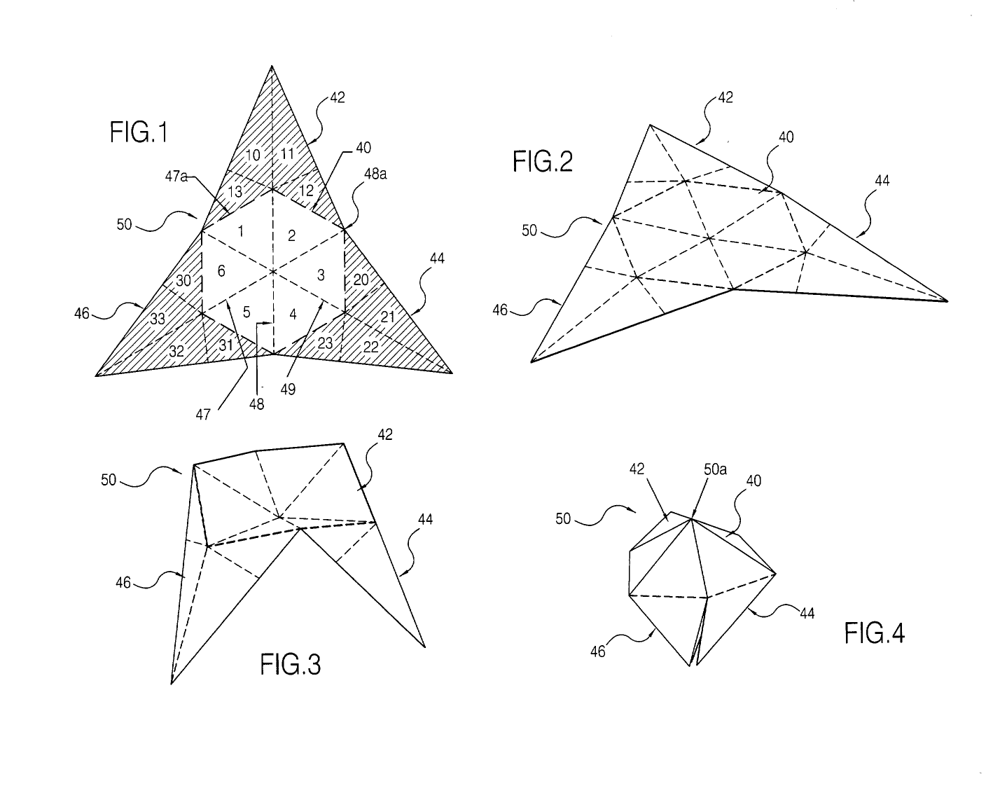

FIG. 2 shows covering element 50 in perspective view. FIG. 3 shows element 50 in a partially folded condition. Extensions 42, 44 and 46 fold inwards towards central element 40 FIG. 4 shows element 50 in a fully folded condition. It can be seen that, in the fully folded condition, the panel surfaces of the central element 40 will be hidden from view and folded inside the panels of the extensions. Also, the panels of the extensions will meet at a center point 50a, forming an essentially continuous surface. By having different printed information/pictures on different panels, different combinations of designs can be achieved. For example, a first design can be visible when the truss structure is fully expanded, and a second design will be visible (and the first design hidden from view and folded within) when the truss structure is fully contracted.

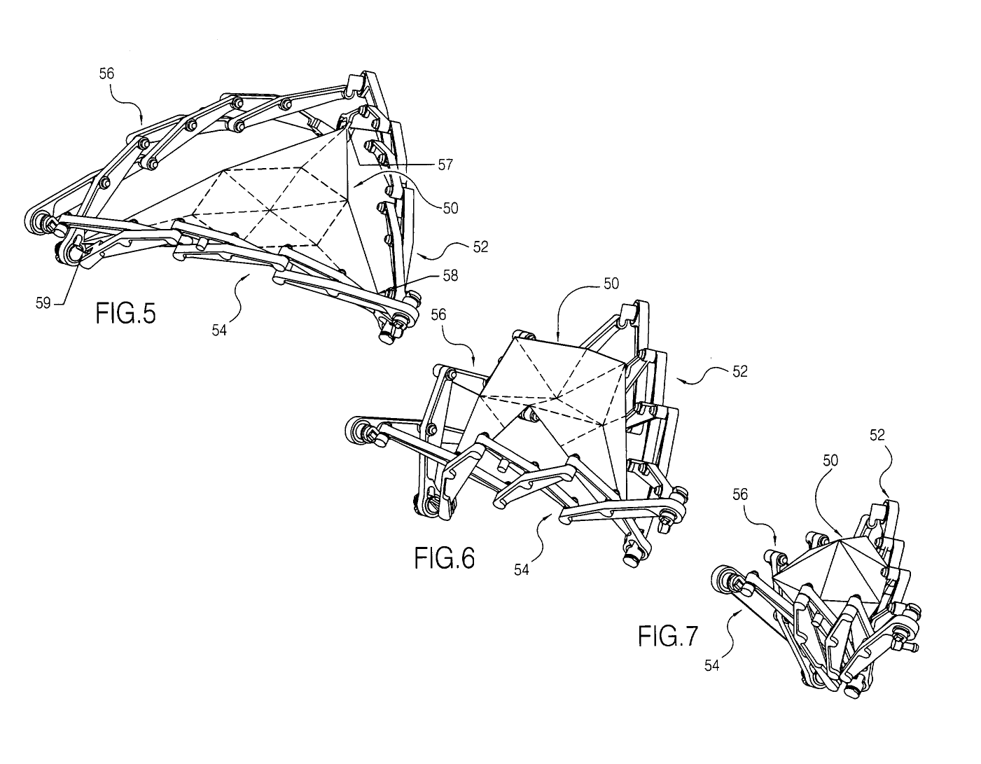

FIG. 5 shows covering element 50 attached to three tong linkages 52, 54 and 56 by three points 57, 58 and 59. These tong linkages, connected to one another to form a closed loop, can freely expand and contract. FIG. 6 shows the linkages in a partially contracted position, thereby compressing and folding up covering element 50. FIG. 7 shows the tong linkages in their fully contracted position, which in turn fully compresses element 50.

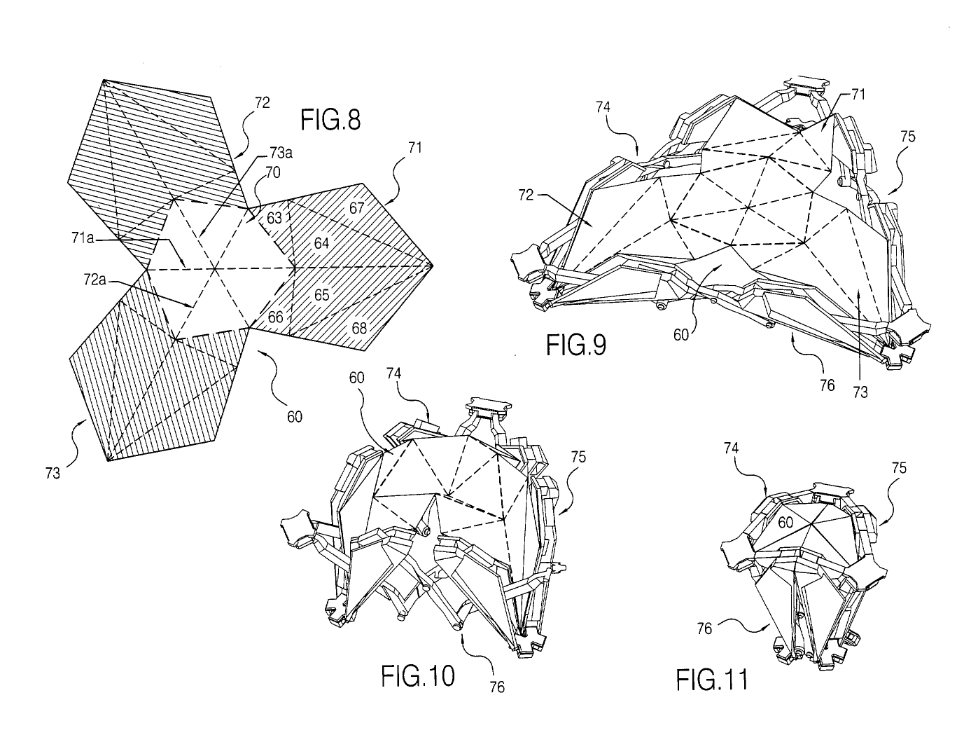

FIG. 8 shows an alternate embodiment of the invention which is a covering element 60 comprised of a central six-sided polygonal element 70, and three extensions 71, 72 and 73 Extension 71 is comprised of six triangular panels 63, 64, 65, 66, 67 and 68 formed by folds 71a, 72a and 73a in the material of the covering element.

FIG. 9 shows covering element 60 attached to three tong linkages 74, 75 and 76 (again forming a closed loop). The attachments of the covering element are made by hinge connections along the perimeter of the three extensions 71, 72 and 73. FIGS. 10 and 11 show the tong linkages in their partially contracted and fully contracted positions respectively thereby compressing and folding up element 70.

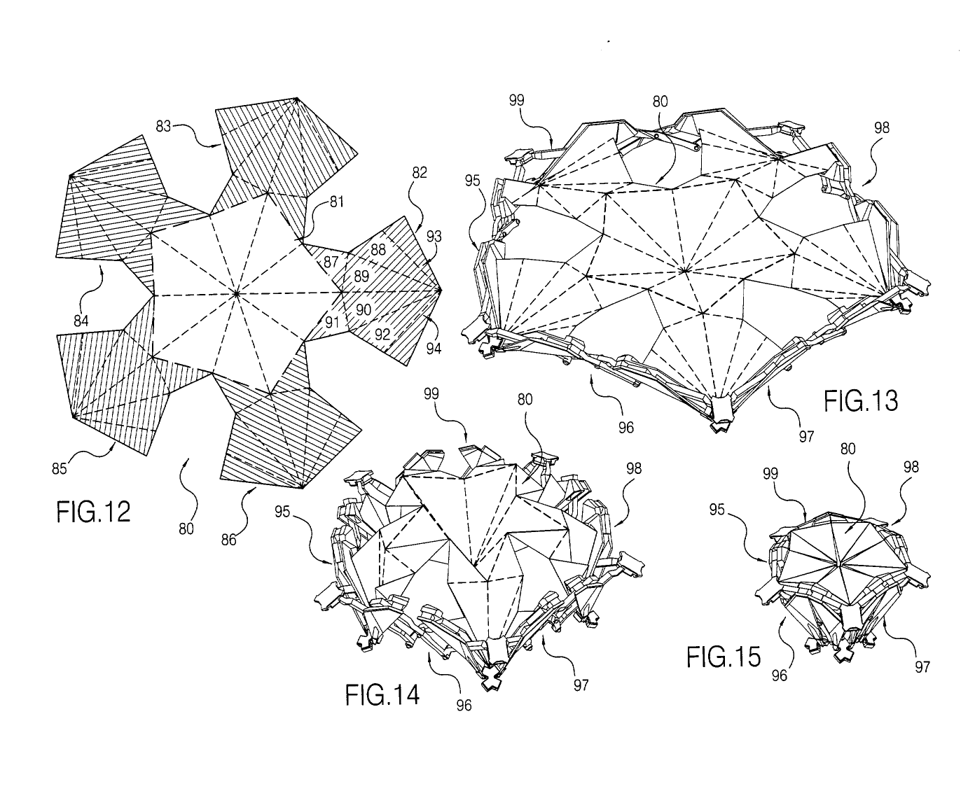

FIG. 12 shows a covering element 80 which is comprised of a ten-sided polygonal element 81 and five extensions 82, 83, 84, 85 and 86. Extension 82 is comprised of eight triangular panels 87, 88, 89, 90, 91, 92, 93 and 94. Again, the panels are formed by folds in the material of the covering element. FIG. 13 shows element 80 attached to five tong linkages 95, 96, 97, 98 and 99 These tong linkages are shown in their extended position. FIGS. 14 and 15 show the tong linkages in their partially contracted and fully contracted positions respectively, in turn compressing and folding up element 80.

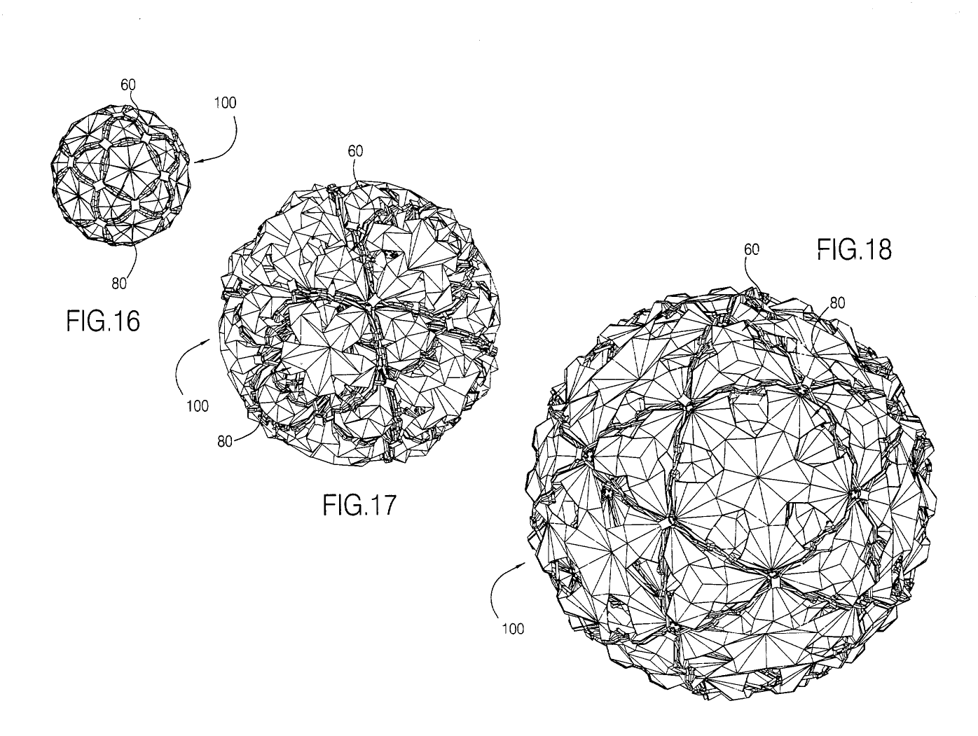

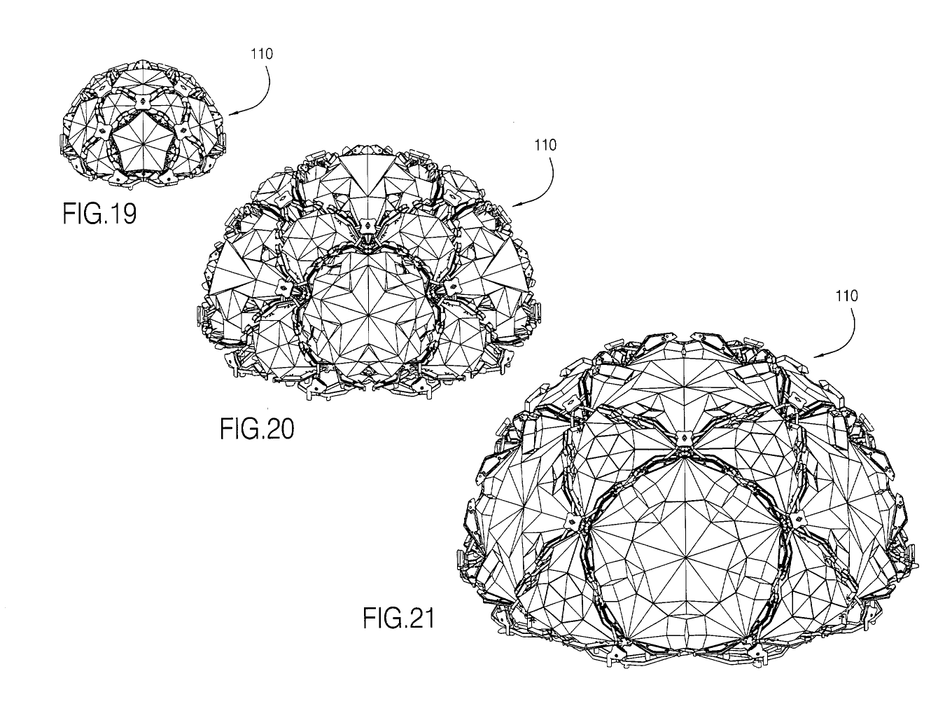

Complex structures can be created from linking together the elements (i.e., tong linkages with covering elements attached) discussed above. FIG. 16 shows an expanding sphere 100 consisting of sixty tong linkages, twelve pentagonal covering elements and twenty triangular covering elements. Expanding sphere 100 is shown in its fully compressed position. FIG. 17 shows the expanding sphere 100 in its partially folded position. FIG. 18 shows 100 in its fully extended position, the covering elements providing a “skin” for the sphere that essential covers the entire outer surface.

FIGS. 19, 20 and 21 show an alternate embodiment of the invention, which is an expanding dome 110 consisting of thirty-five tong linkages, six pentagonal elements and ten triangular elements FIG. 19 shows the expanding dome 110 in its fully folded position. FIGS. 20 and 21 show 110 in its partially folded and fully extended positions respectively.

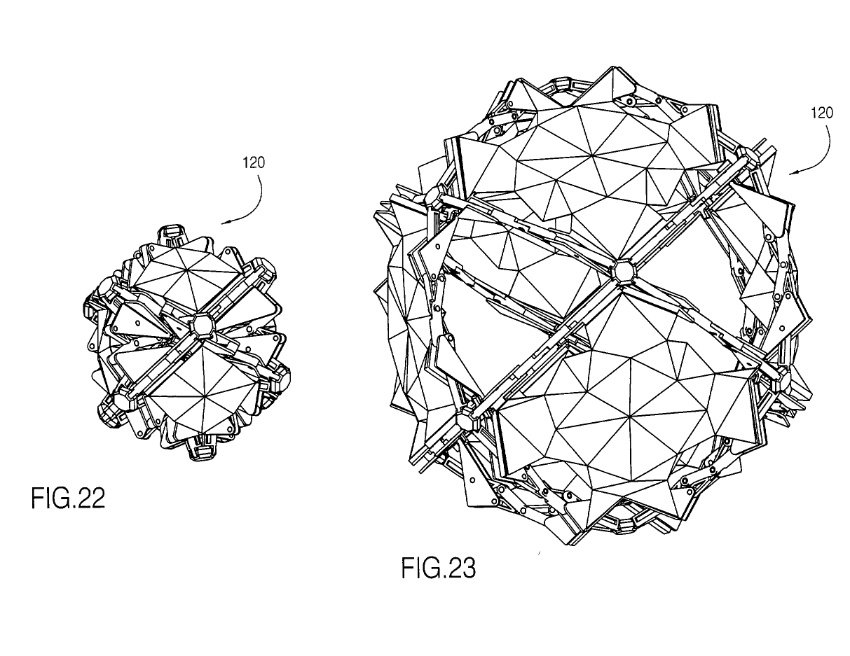

FIG. 22 shows another alternate embodiment of the invention which is a expanding sphere 120 consisting of twenty-four tong linkages and six square covering elements Sphere 120 is shown in its fully compressed position. FIG. 23 shows sphere 120 in its extended position

In alternative embodiments of the invention, panels on the covering elements can be constructed of separate pieces of material that are attached to one another by hinges to form the covering element.

It will be appreciated that the instant specification, drawings and claims set forth by way of illustration and not limitation, and that various modification and changes may be made without departing from the spirit and scope of the present invention.

What is claimed is:

1. A covering element for reversibly expandable truss structures, said covering element formed of a single piece of material and comprising:
a central polygonal area which is comprised of at least six triangular panels which share a common central vertex, said six triangular panels formed by folds in the material of the covering element;
at least three extensions comprised of at least two panels each, said extensions formed by folds in the material of the covering element and are connected to two perimeter edges of said central polygonal area;
whereby said covering element is attached to a reversibly expandable truss structure by attaching the outermost corner of said extensions to a hub element of said reversibly expandable truss structure.

2. A covering element for reversibly expandable truss structures, said covering element formed of a single piece of material and comprising:
a central polygonal area which is comprised of at least six triangular panels which share a common central vertex, said six triangular panels formed by folds in the material of the covering element;
at least three extensions comprised of at least two panels each, said extensions formed by folds in the material of the covering element and are connected to two perimeter edges of aforesaid central polygonal area, said at least three extensions each having two edges;
whereby said covering element is attached to a reversibly expandable truss structure by attaching each edge of said at least three extensions along each edge's length to a strut of a reversibly expandable structure.

3. A covering element for reversibly expandable truss structures, said covering element comprising:
a central polygonal area which is comprised of at least six triangular panels which are hingedly connected to one another and share a common central vertex,
at least three extensions comprised of at least two panels each, said at least two panels hingedly connected to one another, and each of said at least two panels is hingedly connected to a perimeter edge of said central polygonal area;
whereby said covering element is attached to a reversibly expandable truss structure by attaching the outermost corner of said extensions to a hub element of said reversibly expandable truss structure

4. A covering element for reversibly expandable truss structures, said covering element comprising:
a central polygonal area which is comprised of at least six triangular panels which are hingedly connected to one another and share a common central vertex;
at least three extensions comprised of at least two panels each, said at least two panels hingedly connected to one another, and each of said at least two panels is hingedly connected to a perimeter edge of said central polygonal area;
whereby said covering element is attached to a reversibly expandable truss structure by attaching each edge of said at least three extensions along each edge's length to a strut of a reversibly expandable structure.

5. A covered closed-loop reversibly expandable truss structure element, comprising
a closed-loop truss structure comprised of at least three tong assemblies connected to one another to form a closed loop, and
the cover elements of claims 1, 2, 3 or 4 being connected to said closed-loop truss structure.

6. A reversibly expandable dome with covering elements, comprising:
a plurality of covered closed-loop reversibly expandable truss structure elements of claim 5.

7. A reversibly expandable globe with covering elements, comprising:
a plurality of covered closed-loop reversibly expandable truss structure elements of claim 5.

8. A covering element for reversibly expandable truss structures according to claims 1, 2, 3 and 4, wherein the covering element is constructed of cardboard material.

9. A covering element for reversibly expandable truss structures according to claims 1, 2, 3 and 4 wherein the covering element is constructed of plastic.

10. A covering element for reversibly expandable truss structures according to claims 1, 2, 3 and 4, wherein the panels of the covering element has a printed design.

11. A covering element for reversibly expandable truss structures according to claim 10, wherein the printed design forms a first design when the truss structure is fully contracted, and forms a second design when the truss structure is fully expanded.
